(19) United States
(12) Patent Application Publication
(10) Pub. No.: US 2008/0093148 A1
(43) Pub. Date: Apr. 24, 2008

(54) ELECTRIC TWO-WHEELED VEHICLE

(75) Inventor: Tomoyasu Takahashi, Shizuoka-Ken (JP)

Correspondence Address: KNOBBE MARTENS OLSON & BEAR LLP, 2040 MAIN STREET, FOURTEENTH FLOOR, IRVINE, CA, 92614, US

(73) Assignee: YAMAHA HATSUDOKI KABUSHIKI KAISHA, Shizuoka-ken (JP)

(21) Appl. No.: 11/872,505

(22) Filed: Oct. 15, 2007

(30) Foreign Application Priority Data
Oct. 18, 2006 (JP) 2006-283647

(51) Int. Cl. B62K 11/00

(52) U.S. Cl. 180/220

(57) ABSTRACT

A vehicle is powered by an electric motor that receives power from at least one of a fuel cell unit and a secondary batter. The fuel cell unit comprises a controller and a fuel cell stack. A hydrogen cylinder is positioned behind the secondary battery. A body cover generally encloses the fuel cell controller, the fuel cell stack, the secondary battery and the hydrogen cylinder. The body cover comprises an air inlet at a front end thereof and air outlets at a rear end of the body cover. An air passage 61 is defined within the body cover between the inlet and the outlets and the fuel cell controller, the secondary battery and the hydrogen cylinder can be arranged in that order from front to back.

### CROSS-REFERENCE TO RELATED APPLICATIONS

The present application claims the priority benefit of Japanese Patent Application No. 2006-283647, which was filed on Oct. 18, 2006 and which is hereby incorporated by reference in its entirety.

### BACKGROUND OF THE INVENTION

1. Field of the Invention

The present invention generally relates to an electric two-wheeled vehicle with a motor using a fuel cell and a secondary battery as a power source. More particularly, the present invention relates to such a vehicle in which the electric motor drives a wheel to propel the vehicle.

2. Description of the Related Art Japanese Patent Application No. 2002-362470 discloses a two-wheeled electric vehicle that is powered by an electric motor. More particularly, the vehicle is an electric bicycle in which pedaling force generated by a rider and motor power are combined and transmitted together to a rear wheel.

The vehicle also has a fuel cell unit disposed below a seat and in front of the rear wheel. The fuel cell unit is enclosed in a casing. The casing encloses a fuel cell stack, a fuel cell controller, a secondary battery, a fuel tank and the like. Together, these components define the fuel cell unit.

The casing has a ram air inlet in a lower front portion of the casing. The casing also has a ram air outlet in an upper rear portion of the casing. The casing is designed to conduct airflow from the ram air inlet to the ram air outlet such that the airflow cools the various components housed in the casing.

Of the above various components enclosed in the casing, the fuel cell stack is positioned generally in a vertical middle portion of the casing and the fuel cell controller is positioned closely in front of or below the fuel cell stack. The secondary battery is positioned at the bottom in the casing and the fuel tank is positioned close to the ram air outlet of the casing.

In front of the fuel cell stack and in a position below the fuel stack, there is provided a heat insulator to reduce the likelihood that cooling of the fuel stack will result in a reduction in electricity generation efficiency. In other words, air contacting the outside of the casing also can have a cooling effect on the fuel cell unit and the insulation reduces the likelihood of undesired levels of cooling beyond that anticipated by the airflow between the ram air inlet and the ram air outlet.

### SUMMARY OF THE INVENTION

Unfortunately, the fuel cell unit is unlikely to be properly cooled solely by the airflow between the ram air inlet and the ram air outlet. One of the possible reasons for this is that a head wind flowing through the ram air inlet into the casing first cools the secondary battery and then cools the fuel cell controller. That is, the fuel cell controller, which has a relatively high heat release value, cannot be cooled effectively by the head wind. Another possible reason is that, because the fuel cell stack is exposed to the head wind, it is difficult to keep the fuel cell stack at temperatures high enough to provide maximum electricity generation efficiency.

Thus, there remains a need for a structure in which the temperature of the various components of the fuel cell unit can be better controlled. Therefore, it is an object of the present invention to provide an electric two-wheeled vehicle in which a fuel cell stack is kept at temperatures high enough to provide enhanced electricity generation efficiency while the other components of a fuel cell unit are cooled by a head wind to desired temperatures.

Accordingly, one aspect of an embodiment of the present invention involves an electric two-wheeled vehicle comprising a fuel cell unit comprising a fuel cell stack and a fuel cell controller. A hydrogen storage container is adapted to store a hydrogen gas to be supplied to the fuel cell unit. A secondary battery is rechargeable by the fuel cell unit. A motor is supplied with electricity from at least one of the fuel cell unit and the secondary battery to rotate a drive wheel. The fuel cell controller is positioned on the fuel cell stack. The secondary battery is positioned in a rearward of the fuel cell controller. The hydrogen storage container is positioned rearward of the secondary battery. A cover surrounds the fuel cell controller, the fuel cell stack, the secondary battery and the hydrogen storage container in a vertical direction and on both lateral sides thereof. The cover comprises an air inlet at a front end of the cover at a location vertically higher than the fuel cell stack, an air outlet at a rear end of the cover, and an air passage is defined within the cover between the air inlet and the air outlet. The air passage encloses therein the fuel cell controller, the secondary battery and the hydrogen storage container.

Another aspect of an embodiment of the present invention involves an electric two wheeled vehicle. The vehicle comprises a frame and a seat supported by the frame. The frame is supported by a front wheel and a rear wheel. At least one of the wheels is drivingly connected to an electric motor. The electric motor receives power from at least one of a fuel cell unit and a secondary battery. The fuel cell unit supplies power to the secondary battery. The fuel cell unit comprises a fuel cell stack and a fuel cell controller. A case generally encloses the fuel cell stack and the fuel cell controller. The case comprises a lower portion and an upper portion. The fuel cell stack is positioned in the lower portion and the fuel cell controller is positioned in the upper portion. The upper portion comprises at least one lateral side wall and at least one top wall. A heat sink is connected to at least one of the at least one lateral side wall and the at least one top wall and a space is defined between the heat sink and an outer cover.

### BRIEF DESCRIPTION OF THE DRAWINGS

These and other features, aspects and advantages of the present invention will now be described with reference to drawings of a preferred embodiment, which embodiment is intended to illustrate and not to limit the invention.

FIG. 1 is a side elevation illustrating an electric two-wheeled vehicle having a body cover, which vehicle is arranged and configured in accordance with certain features, aspects and advantages of an embodiment of the present invention.

FIG. 2 is a front elevation illustrating the body cover of FIG. 1.

FIG. 3 is a perspective view illustrating the body cover of FIG. 1.

FIG. 4 is a vertical cross-sectional view of the body cover and a case.

FIG. 5 is a perspective view taken from the front left side of the electric two-wheeled vehicle of FIG. 1.

FIG. 6 is a side elevation of the electric two-wheeled vehicle of FIG. 1.

FIG. 7 is a perspective view taken from the rear right side of the electric two-wheeled vehicle of FIG. 1.

### DETAILED DESCRIPTION OF THE PREFERRED EMBODIMENT

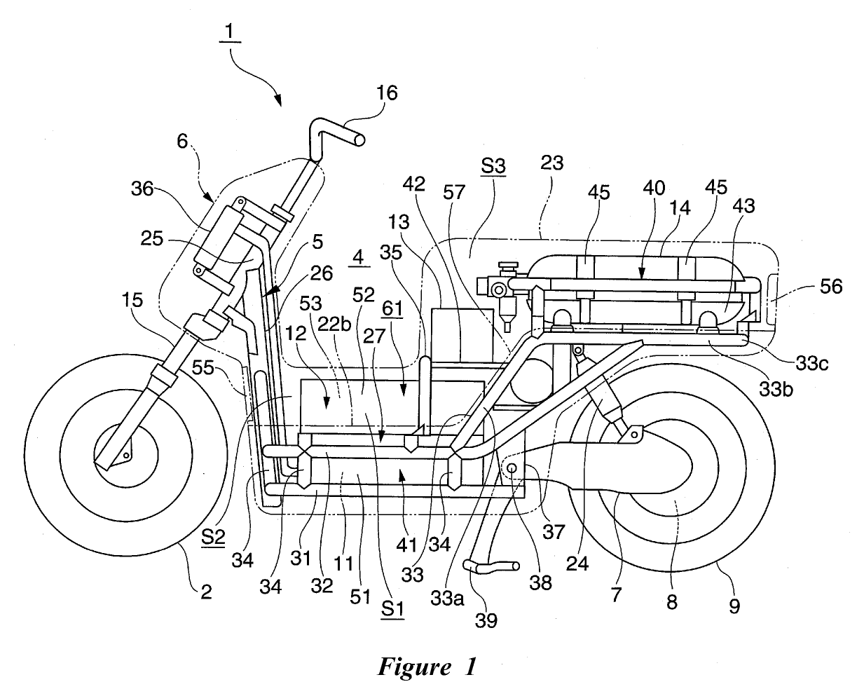

With reference initially to FIG. 1, a motorcycle 1 is illustrated. The motorcycle 1 is arranged and configured in accordance with certain features, aspects and advantages of an embodiment of the present invention. Preferably, the motorcycle 1 is an electric two-wheeled vehicle of a scooter-type. The illustrated motorcycle 1 has a leg space 4 defined between a front wheel 2 and a seat 3. The motorcycle 1 includes a cover 6 that covers or shrouds components of a vehicle body, including a body frame 5 (see FIG. 1), which will be described below.

In one configuration, the vehicle 1 is driven by a motor 8 that is positioned in rear arms 7. In other words, the motor 8 that drives the rear wheel 9 preferably is integrated into the rear arms 7 or supported by the rear arms 7.

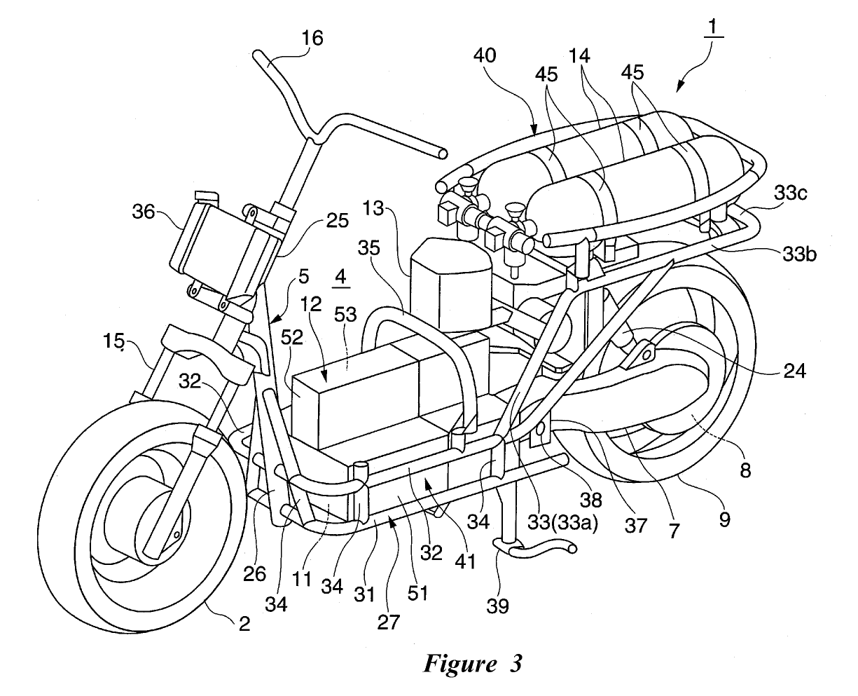

With reference to FIGS. 1 and 3, a fuel cell unit 12 and a secondary battery 13 are used as a power source for the motor 8. The fuel cell unit 12 has a fuel cell stack 11 and is installed generally below the leg space 4. The secondary battery 13 is charged by the fuel cell unit 12. The fuel cell unit 12 can generate electricity using hydrogen supplied from two hydrogen cylinders 14, which are provided at a rear portion of the illustrated vehicle, and oxygen in the ambient atmosphere. The hydrogen cylinders 14 are one form of a hydrogen storage container but any other suitable hydrogen storage containers can be used.

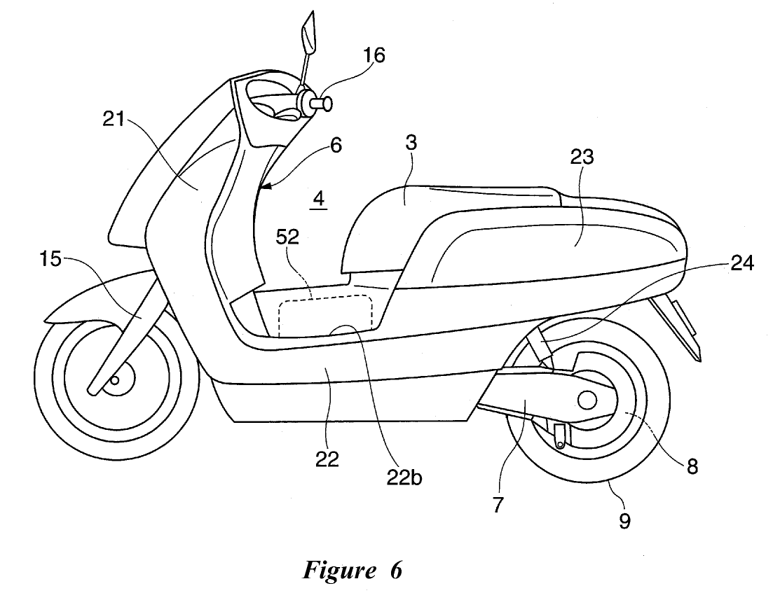

With reference to FIG. 6, the illustrated body cover 6 comprises a front section 21, a footrest section 22 and a rear section 23. The front section 21 preferably covers an upper portion of the front forks 15 and a lower portion of a steering handlebar 16. The illustrated footrest section 22 extends from the lower end of the front section 21 to a lower front portion of a seat 3 while passing through a lower portion of the leg space 4. The illustrated rear section 23 extends from the rear portion of the footrest section 22 to a location generally above the rear wheel while passing along a lower portion of the seat 3.

As shown in FIGS. 1, 2 and 5 through 7, the front section 21 and the rear section 23 preferably cover the portions of the vehicle body other than portions through which the front forks 15, the rear arms 7 and a rear cushion unit 24 extend, both in a vertical direction and in a vehicle width direction.

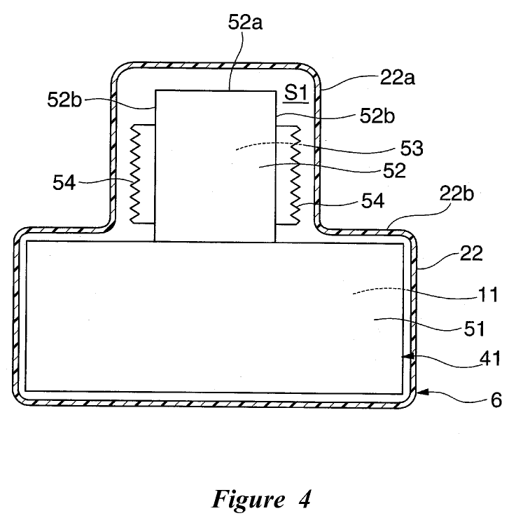

As shown in FIG. 4, the footrest section 22, forming the bottom of the illustrated leg space 44, of the body cover 6 has an upward-projecting cross section as seen in a longitudinal direction of the vehicle body. On the footrest section 22, there are formed an upwardly extending projection 22a at the middle in the vehicle width direction, and a footrest 22b on both lateral sides of the projection 22a.

The electric two-wheeled vehicle 1 is driven by a rider straddling or otherwise sitting on the seat 3 as he/she grips the steering handlebar 16 in a forward direction of the rider with his/her feet on the footrest 22b.

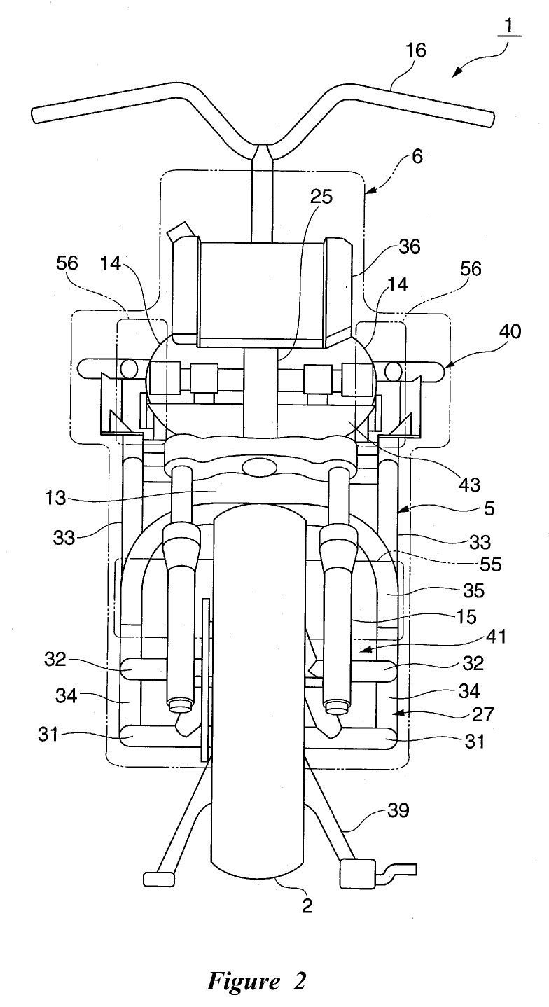

As shown in FIGS. 1 and 2, the body frame 5 of the electric two-wheeled vehicle 1 comprises a head pipe 25 that supports the front forks 15 and the steering handlebar 16 that is used to steer the vehicle, a down tube 26 that extends downward from the head pipe 25, and a main frame 27 that comprises a plurality of pipes welded to a lower portion of the down tube 26.

The main frame 27 comprises a pair of left and right lower pipes 31, a pair of left and right middle pipes 32, an upper pipe 33, a plurality of reinforcement pipes 34, a cross member 35 and the like. The lower pipes 31 are welded to the lower end of the down tube 26. The middle pipes 32 are welded to the down tube 26 in a position above the lower pipes 31. The upper pipe 33 is welded to middle portions of the middle pipes 32 and extends upward.

A radiator 36 can be attached to the headpipe 25. The radiator is used as a heat exchanger for fluid that flows through the fuel cell stack 11 to cool the fuel cell stack 11.

As shown in FIG. 2 and in FIG. 3, on the front side of the vehicle body, the lower pipes 31 and the middle pipes 32 extend rearward on both lateral sides of the footrest 22. The middle pipe 32 is angled at a portion corresponding to the rear end of the footrest 22 and extends obliquely upward and rearward.

These inclined portions of the middle pipes 32 are provided with a pair of left and right rear arm brackets 37. The brackets 37 are used to connect the front ends of the rear arms 7. A pivot shaft 38 extends between, and is attached to, the left rear arm bracket 37 and the right rear arm bracket 37. The front end of the rear arm 7 is pivotably supported about the pivot shaft 38 for vertical pivotal movement. A main stand 39 can be attached to the vehicle at a location below the front end of the rear arm 7.

The upper pipe 33 comprises left and right front portions 33a, 33a, left and right rear portions 33b, 33b, and a lateral portion 33c. The left and right front portions 33a, 33a extend obliquely upward and rearward from the respective middle pipes 32 in proximity to front portions of the angled portions of the middle pipes 32. The left and right rear portions 33b and 33b extend generally horizontally above the rear wheel 9 in the longitudinal direction of the vehicle body, as seen in the side view. The lateral portion 33c connects the rear ends of the rear portions 33b, 33b. As seen in the plan view, the illustrated upper pipe is in a U-configuration that is open forward.

The width of the upper pipe 33 in the vehicle width direction preferably is about the same as the width between the left and right middle pipes 32. The seat 3 preferably is positioned generally above the front portions of the upper pipe 33. A protector 40 preferably is positioned generally above the rear portions 33b and the lateral portion 33c of the upper pipe 33. The protector 40 preferably surrounds the hydrogen cylinders 14 on the lateral sides and the rear side thereof.

The rear cushion unit 24 is disposed between the left rear portion 33b of the upper pipe 33 and the rear arm 7. The rear portion 33b preferably is welded at the longitudinal middle to the rear end of the middle pipe 32 such that it can be supported by the middle pipe 32 from below.

As shown in FIGS. 1 to 3, the fuel cell unit 12 preferably is enclosed in a case 41 installed at the bottom of the leg space 4. As shown in FIG. 1, the secondary battery 13, which is rechargeable by the fuel cell unit 12, is disposed generally above the rear end of the case 41 and below the seat 3. The secondary battery 13 can be supported by the upper pipe 33 and the cross member 35 of the body frame 5 via a stay 42.

The two hydrogen cylinders 14, 14, which contain hydrogen gas to be supplied to the fuel cell unit 12, can be placed on a tank holder 43, which can be positioned at a rear portion of the vehicle body. The cylinders 14, 14 preferably are arranged side by side in the vehicle width direction such that they extend generally in the longitudinal direction of the vehicle body. Each hydrogen cylinder can be tightly secured to the tank holder 43 with bands 45, for instance. The tank holder 43 can be supported by the rear portion 33b of the upper pipe 33 of the body frame 5.

As shown in FIG. 4, the case 41 that holds the fuel cell unit 12 can project upward when viewed in the longitudinal direction of the vehicle body. Preferably, the case 41 is enclosed in the footrest section 22 of the body cover 6. More specifically, the case 41 preferably comprises a bottom portion 51 and an upper projection 52. The bottom portion 51 can comprise a relatively large dimension in the vehicle width direction (i.e., when viewed from the front of the vehicle). The upper projection 52 preferably projects upward from the upper end of the case 41 at the middle in the vehicle width direction. The upper projection 52 can be inserted into the projection 22a of the body cover 6 from below. The case 41 can be fixed to, or supported by, the lower pipes 31 of the body frame 5. In FIG. 4, the footrest section 22 of the body cover 6 is shown as an integral piece. In one embodiment, the body cover 6 can be formed by a plurality of covers (not shown) assembled together.

The fuel cell unit 12 comprises a fuel cell stack 11 enclosed in the bottom portion 51 of the illustrated case 41, a fuel cell controller 53 enclosed in the upper projection 52 of the illustrated case 41, and the like. The fuel cell controller preferably is in contact with a top wall 52a and lateral sidewalls 52b, which together define at least a portion of the upper projection 52 in the illustrated configuration, for heat transfer between the fuel cell controller and the upper projection 52. It should be noted that, although not shown, fuel cell components also can be enclosed in a rear portion of the case 41.

As shown in FIG. 4, the upper projection 52 of the case 41 and the footrest section 22 of the body cover 6 (including, in some embodiments, the projection 22a) define a space S1 therebetween. In the illustrated embodiment, to both lateral sides of the upper projection 52 of the case 41, heat sinks 54 can be attached to extend generally in the vertical and longitudinal directions within the space S1. In one embodiment, the bottom portion 51 of the case 41 and the footrest section 22 of the body cover 6 define a much smaller gap relative to the space S1 between the upper projection 52 and the footrest section 22.

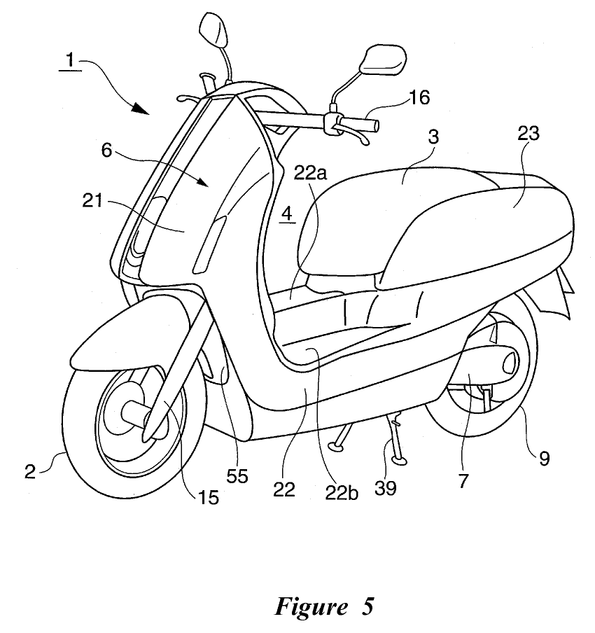

The space S1 preferably surrounds the upper projection 52 on the upper side and on both lateral sides and preferably extends in the longitudinal direction of the vehicle body in the footrest section 22. At the front end of the footrest section, the space S1 preferably communicates with a head wind or ram air inlet 55 (see FIGS. 1 and 5) formed at the front end of the body cover 6. In one configuration, a passage is defined through a space S2 in the body cover 6 such that the inlet 55 and the space S1 are placed in fluid communication with each other. As shown in FIG. 1, the head wind inlet 55 can be formed in the body cover 6 in a position behind the front wheel 2 and above the bottom portion 51 of the case 41, which contains the fuel cell stack 11 in the illustrated configuration, to be open in a forward end of the vehicle body. As shown in FIG. 2, the inlet 55 extends from the left end to the right end of the body cover 6 in FIG. 2.

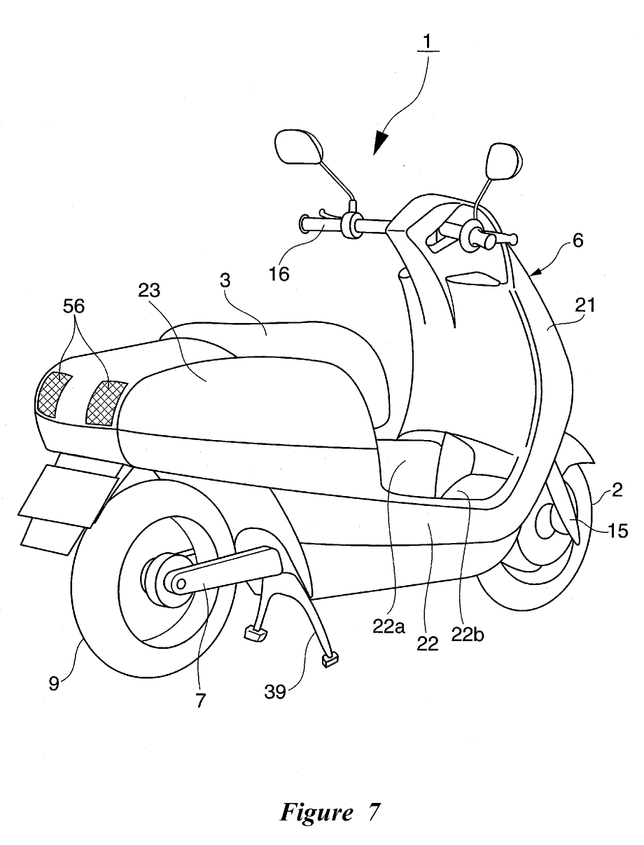

As shown in FIGS. 1 and 7, at the rear end of the illustrated footrest section, the space S1 communicates with air outlets 56 formed at the rear end of the body cover 6, preferably through a space S3 defined within the body cover 6. The space S3 can be formed in the rear section 23 of the body cover 6. As shown in FIG. 2, two air outlets 56 can be formed in an upper portion of the rear section 23 of the body cover to be positioned in proximity to the lateral sides of the hydrogen cylinders 14 as seen in the longitudinal direction of the vehicle body.

The space S3 preferably is defined by an upper wall formed by the seat 3 and the upper end of the body cover 6; a pair of left and right sidewalls formed by both lateral sides of the rear section of the body cover 6; and a bottom wall 57 (see FIG. 1) formed by a tubular member extending in the longitudinal direction of the vehicle body in the rear section of the body cover 6. Other configurations also can be used. The bottom wall 57 preferably extends obliquely upward and rearward from the rear end of the footrest 22b of the body cover 6 along the front portions 33a of the upper pipe 33, and further extends rearward along the rear portions 33b of the upper pipe 33. In a front portion of the space S3, the secondary battery 13 can be disposed, and in a rear portion of the space S3, the hydrogen cylinders 14 can be disposed.

These spaces S1, S2 and S3 preferably define a connecting space extending in the longitudinal direction of the vehicle body. In other words, the illustrated electric two-wheeled vehicle 1 comprises an air passage 61 formed by the spaces S1, S2, S3 in the body cover 6 between the air inlet 55 and the air outlets 56. In the air passage 61, the fuel cell controller 53, the secondary battery 13 and the hydrogen cylinders 14 can be disposed in series, preferably in that order.

Air preferably flows through the air inlet 55 into the air passage 61 as the vehicle is driven. The air flows from the space S2 to the space S1 between the body cover 6 and the case 41, and as the air passes through the space S1, the upper projection 52 of the case 41 will be exposed to the airflow. More specifically, the upper wall 52a and lateral sidewalls 52b, 52b of the upper projection 52, as well as the heat sinks 54 will be exposed to the air, which cools the fuel cell controller 53.

Thereafter, the air flows into the space S3 to cool the secondary battery 13 and the hydrogen cylinders 14 before escaping rearward of the body cover 6 through the air outlets 56.

Because the fuel cell stack 11, which is in the body cover 6, is positioned outside of the air passage 61 described above, unnecessary cooling of the fuel cell stack due to the air flow is less likely without additional use of a heat insulator.

Thus, in the illustrated electric two-wheeled vehicle 1, the temperature of the fuel cell stack 11 can be raised promptly and kept to temperatures high enough to enhance electricity generation efficiency. Further, in the illustrated electric two-wheeled vehicle 1, the fuel cell controller 53 can be positioned in proximity to the downstream side of the air inlet 55. This makes it possible to effectively cool the fuel cell controller 53 having a relatively high heat release value by the air flow having the lowest temperature (i.e., the air flow will absorb heat at it passes toward the air outlets). Furthermore, the secondary battery 13 and the hydrogen cylinders 14, which release relatively less heat. Accordingly, they can be cooled well even by the air that has already been used to cool the fuel cell controller 53.

Further, the illustrated air inlet 55 is provided closely behind the front wheel 2. This allows a head wind to enter the air passage 61 more easily, and thus a larger volume of a head wind can be introduced therein to provide more enhanced cooling efficiency of the above components.

The illustrated head wind passage 61 (space S1) preferably is formed above and on the lateral sides of the upper projection 52 of the case 41 (fuel cell controller 53). Thus, the fuel cell controller 53 can be cooled both on the upper side and on the lateral sides thereof. As a result, the volume of a head wind flowing through the head wind passage 61 increases, and also the area of the upper projection 52 that is exposed to the head wind increases. This provides more effective cooling for the fuel cell controller 53.

Although the present invention has been described in terms of a certain embodiment, other embodiments apparent to those of ordinary skill in the art also are within the scope of this invention. Thus, various changes and modifications may be made without departing from the spirit and scope of the invention. For instance, various components may be repositioned as desired. Moreover, not all of the features, aspects and advantages are necessarily required to practice the present invention. Accordingly, the scope of the present invention is intended to be defined only by the claims that follow.

1. An electric two-wheeled vehicle comprising:
a fuel cell unit comprising a fuel cell stack and a fuel cell controller;
a hydrogen storage container adapted to store a hydrogen gas to be supplied to the fuel cell unit;
a secondary battery rechargeable by the fuel cell unit;
a motor supplied with electricity from at least one of the fuel cell unit and the secondary battery to rotate a drive wheel;
the fuel cell controller being positioned on the fuel cell stack;
the secondary battery being positioned in a rearward of the fuel cell controller;
the hydrogen storage container being positioned rearward of the secondary battery;
a cover surrounding the fuel cell controller, the fuel cell stack, the secondary battery and the hydrogen storage container in a vertical direction and on both lateral sides thereof, the cover comprising:
an air inlet at a front end of the cover at a location vertically higher than the fuel cell stack;
an air outlet at a rear end of the cover; and
an air passage defined within the cover between the air inlet and the air outlet, the air passage enclosing therein the fuel cell controller, the secondary battery and the hydrogen storage container.

2. The electric two-wheeled vehicle according to claim 1, further comprising:
a front wheel and a seat, and a leg space defined therebetween;
a case shaped to project upward, the case enclosing therein the fuel cell stack and the fuel cell controller and being positioned generally below the leg space:
the fuel cell stack being positioned at a lower portion of the case;
the fuel cell controller being positioned in an upper projection of the case; and
the air passage being defined between the body cover and at least one lateral side and the upper side of the upper projection.

3. An electric two wheeled vehicle, the vehicle comprising a frame, a seat supported by the frame, the frame being supported by a front wheel and a rear wheel, at least one of the wheels being drivingly connected to an electric motor, the electric motor receiving power from at least one of a fuel cell unit and a secondary battery, said fuel cell unit supplying power to said secondary batter, said fuel cell unit comprising a fuel cell stack and a fuel cell controller, a case generally enclosing said fuel cell stack and said fuel cell controller, said case comprising a lower portion and an upper portion, said fuel cell stack being positioned in said lower portion and said fuel cell controller being positioned in said upper portion, said upper portion comprising at least one lateral side wall and at least one top wall, a heat sink being connected to at least one of said at least one lateral side wall and said at least one top wall and a space being defined between said heat sink and an outer cover.

4. The vehicle of claim 3, wherein the motor and a rear arm are pivotally connected to the frame.

5. The vehicle of claim 3 further comprising a second heat sink that is connected to another of said at least one lateral side wall and said at least one top wall, a space being defined between said second heat sink and said outer cover.

6. The vehicle of claim 3, wherein said upper portion comprises a first lateral side wall and a second lateral side wall, said upper portion also comprising one top wall and said top wall extending between said first lateral side wall and said second lateral side wall.

7. The vehicle of claim 6, wherein said heat sink is positioned between said outer cover and said first lateral wall.

8. The vehicle of claim 7 further comprising a second heat sink that is connected to at least one of said top wall and said second lateral wall, a space being defined between said outer cover and said second heat sink.

9. The vehicle of claim 3, wherein said case is enclosed within said outer cover and said outer cover defines, at least in part, at least a portion of a footrest.

10. The vehicle of claim 3, wherein said lower portion of said case has a larger dimension in a transverse direction of said vehicle than said upper portion of said case.

11. The vehicle of claim 3, wherein said upper portion of said case is spaced further from walls of said outer cover than said lower portion of said case is spaced from walls of said outer cover.

12. The vehicle of claim 3 further comprising an air inlet that is in fluid communication with a region of said outer cover that includes a space defined between said upper portion of said case and said outer cover.

13. The vehicle of claim 12 further comprising an air outlet that is in fluid communication with said region of said outer cover that includes said space defined between said upper portion of said case and said outer cover.

14. The vehicle of claim 13, wherein an air passage is defined through said region between said air inlet and said air outlet.

15. The vehicle of claim 14, wherein said fuel cell controller, said secondary battery and a hydrogen cylinder are positioned from front to back along said air passage.

16. The vehicle of claim 14, wherein said fuel cell stack is positioned outside of said air passage.

17. The vehicle of claim 14, wherein said secondary battery is positioned at least partially within said air passage.

18. The vehicle of claim 14, wherein said air outlet is positioned proximate a hydrogen tank and said air passage extends alongside at least a portion of said hydrogen tank.

19. The vehicle of claim 14, wherein said air inlet faces in a forward direction of the vehicle and said air outlet faces in a direction other than said forward direction of the vehicle.

20. The vehicle of claim 19, wherein said air outlet faces rearward.

21. The vehicle of claim 12, wherein said air inlet is positioned behind said front wheel.

22. An electric two wheeled vehicle, the vehicle comprising a frame, a seat supported by the frame, the frame being supported by a front wheel and a rear wheel, at least one of the wheels being drivingly connected to an electric motor, the electric motor receiving power from at least one of a fuel cell unit and a secondary battery, said fuel cell unit supplying power to said secondary battery, said fuel cell unit comprising a fuel cell stack and a fuel cell controller, a case generally enclosing said fuel cell stack and said fuel cell controller, said case comprising a lower portion and an upper portion, said fuel cell stack being positioned in said lower portion and said fuel cell controller being positioned in said upper portion, said vehicle further comprising means for cooling components of said fuel cell unit.
